(19) United States
(12) Patent Application Publication
(10) Pub. No.: US 2026/0367556 A1
(43) Pub. Date: Nov. 19, 2026

(54) IMAGE FORMING APPARATUS CONTROLLING ROTATION OF CONVEYING UNIT

(71) Applicant: CANON KABUSHIKI KAISHA, Tokyo (JP)

(72) Inventors: NAOYUKI MAEDA, Shizuoka (JP); KO KATAHIRA, Kanagawa (JP); SACHIYORI SHIINA, Shizuoka (JP)

(21) Appl. No.: 19/674,683

(22) Filed: May 12, 2026

(30) Foreign Application Priority Data
May 13, 2025 (JP) 2025-080613
Mar. 3, 2026 (JP) 2026-033560

(51) Int. Cl. G03G 15/23; G03G 15/00; G03G 15/20

(52) U.S. Cl. CPC G03G 15/234; G03G 15/2064; G03G 15/6552; G03G 2215/00599; G03G 2215/00721; G03G 2215/00772; G03G 2215/00776

(57) ABSTRACT

An image forming apparatus capable of single-sided and capable of performing double-sided printing includes a feeding unit, an image forming unit, a heating unit, and a discharge unit discharging sheets to a tray. A first conveying path extends from the feeding unit to the discharge unit via the image forming unit. A second conveying path branches from the first path downstream of the image forming unit and rejoins it upstream. A conveying unit, disposed vertically below the heating unit, conveys sheets through the second conveying path. A control unit controls the conveying unit and is configured to rotate the conveying unit during single-sided printing.

### BACKGROUND

### Field of the Technology

The present disclosure relates to an image forming apparatus controlling rotation of a conveying unit.

### Description of the Related Art

In an image forming apparatus that forms an image on a sheet using heat, moisture contained in the sheet evaporates, and condensation occurs in a conveying path of the sheet. If a subsequent sheet gets wet, it causes a reduction in image quality. According to Japanese Patent Laid-Open No. 2021-056343, it is described that condensation is prevented by blowing air onto a sheet at a double-sided reversing roller disposed in a conveying path through which the sheet passes during double-sided printing, and continuing to rotate the double-sided reversing roller.

However, if the double-sided reversing roller continues to be rotated, power consumption increases, or a large-sized electric component becomes necessary.

In particular, if a large-sized fan is adopted in order to apply air to the double-sided reversing roller, an increase in size of a housing of the image forming apparatus becomes necessary. Furthermore, air blown out from the large-sized fan cools a heater of a fixing device. This causes a fixing failure or increases power consumption of the heater.

### SUMMARY

The disclosure provides an image forming apparatus capable of performing single-sided printing in which an image is formed on a first surface of a sheet and an image is not formed on a second surface of the sheet, and capable of performing double-sided printing in which an image is formed on the first surface of the sheet and an image is formed on the second surface of the sheet, the image forming apparatus comprising: a feeding unit configured to feed the sheet; an image forming unit configured to form an image on the sheet; a heating unit configured to heat the sheet; a discharge tray; a discharge unit configured to discharge the sheet to the discharge tray; a first conveying path extending from the feeding unit to the discharge unit via the image forming unit; a second conveying path branching from the first conveying path on a downstream side of the image forming unit in a conveying direction of the sheet and joining the first conveying path on an upstream side of the image forming unit; a conveying unit disposed below the heating unit in a vertical direction, the conveying unit conveying a sheet passing through the second conveying path; and a control unit configured to control operation of the conveying unit, wherein the control unit rotates the conveying unit in the single-sided printing.

Features of the present disclosure will become apparent from the following description of embodiments with reference to the attached drawings.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram illustrating an image forming apparatus.

FIG. 2 is a diagram illustrating a fixing device and a pair of conveying rollers.

FIGS. 3A to 3C are diagrams illustrating condensation.

FIG. 4 is a diagram illustrating a controller.

FIG. 5 is a flowchart illustrating a control method.

FIG. 6 is a flowchart illustrating condensation reduction processing.

FIG. 7 is a flowchart illustrating condensation reduction processing.

FIG. 8 is a flowchart illustrating condensation reduction processing.

FIG. 9 is a flowchart illustrating condensation reduction processing.

FIG. 10 is a flowchart illustrating condensation reduction processing.

FIG. 11 is a flowchart illustrating condensation reduction processing.

FIG. 12 is a flowchart illustrating condensation reduction processing.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### 1. Image Forming Apparatus

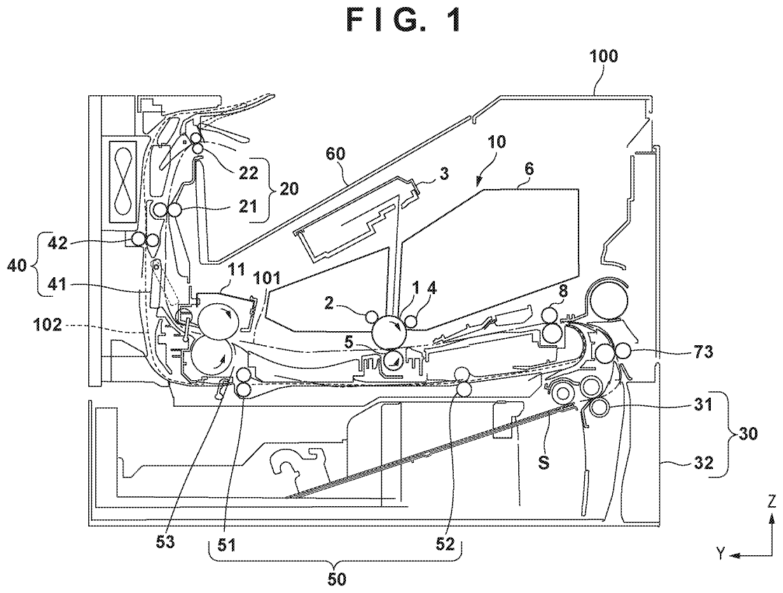

FIG. 1 is a schematic cross-sectional view of an electrophotographic image forming apparatus 100. The image forming apparatus 100 may be any of a printer, a copying machine, or a multifunction peripheral. As long as it is an image forming system having a mechanism that heats a sheet, another image forming system different from the electrophotographic system may be adopted.

The image forming apparatus 100 has an image forming unit 10, a fixing device 11, a discharge unit 20, a feeding unit 30, a reversing unit 40, and a sub-conveying unit 50.

The image forming unit 10 has a process cartridge 6, an exposure device 3, and a transfer roller 5.

The process cartridge 6 has a photosensitive drum 1, a charging roller 2, and a developing roller 4, or the like, and is attachable to and detachable from a housing of the image forming apparatus 100. The photosensitive drum 1 rotates clockwise in FIG. 1. The charging roller 2 charges a surface of the rotating photosensitive drum 1. The exposure device 3 irradiates the surface of the rotating photosensitive drum 1 with light corresponding to an image signal. An electrostatic latent image is thereby formed. The developing roller 4 causes toner to adhere to the surface of the rotating photosensitive drum 1, develops the electrostatic latent image, and forms a toner image (hereinafter, image). The transfer roller 5 forms a transfer portion disposed so as to face the photosensitive drum 1.

The feeding unit 30 includes a sheet cassette 32 capable of accommodating a plurality of sheets S, and a pair of feeding rollers 31 that feeds a sheet from the sheet cassette 32 to a first conveying path 101. A pair of conveying rollers 73 is disposed on a downstream side of the pair of feeding rollers 31 in a conveying direction of the sheet S. The pair of conveying rollers 73 conveys the sheet S to a pair of registration rollers 8. The pair of registration rollers 8 corrects skewing of the sheet S and conveys the sheet S to the image forming unit 10. In the image forming unit 10, the transfer roller 5 transfers an image from the photosensitive drum 1 to the sheet S.

A fixing device 11 is disposed on a downstream side of the image forming unit 10 in the first conveying path 101. The fixing device 11 applies heat and pressure to the sheet S and the image, and fixes the image on the sheet S.

A flapper 41 of the reversing unit 40 is disposed at a branching portion between the first conveying path 101 and a second conveying path 102. The flapper 41 is a guiding member that guides the sheet S discharged from the fixing device 11 to the first conveying path 101 or the second conveying path 102.

In a case of single-sided image formation (single-sided printing), the flapper 41 exists at an initial position shown by a solid line, and delivers the sheet S to a pair of conveying rollers 21 of the discharge unit 20. That is, the sheet S continues to be conveyed through the first conveying path 101. The pair of conveying rollers 21 further conveys the sheet S downstream, and delivers the sheet S to a pair of discharge rollers 22. The pair of discharge rollers 22 of the discharge unit 20 discharges the sheet S to a discharge tray 60 provided outside the image forming apparatus 100.

In a case of double-sided image formation (double-sided printing), the flapper 41 moves to a position shown by a dotted line.

The flapper 41 guides the sheet S having the image formed on a first surface from the first conveying path 101 to the second conveying path 102, and delivers the sheet S to a pair of reversing rollers 42 of the reversing unit 40. The pair of reversing rollers 42 conveys the sheet S in a +Z direction by rotating in a forward direction. When a trailing end of the sheet S is pulled into the second conveying path 102, the pair of reversing rollers 42 starts reversal. Thereby, the sheet S is conveyed in a −Z direction (vertical direction) within the second conveying path 102. Note that, the flapper 41 returns to the initial position so that the sheet S does not return from the second conveying path 102 to the first conveying path 101.

The second conveying path 102 finally joins the first conveying path 101 on an upstream side of the image forming unit 10 and the pair of registration rollers 8. Here, a sub-conveying unit 50 is provided between the branching portion and a joining portion in the second conveying path 102. The sub-conveying unit 50 has pairs of conveying rollers 51, 52. The pair of conveying rollers 51 conveys the sheet S delivered from the pair of reversing rollers 42 in the second conveying path 102, and delivers the sheet S to the pair of conveying rollers 52. The pair of conveying rollers 52 delivers the sheet S to the pair of registration rollers 8. The pair of registration rollers 8 delivers the sheet S to the image forming unit 10. The image forming unit 10 forms an image on a second surface of the sheet S. The fixing device 11 fixes the image on the second surface of the sheet S. The flapper 41 conveys the sheet S having the images formed on both the first surface and the second surface to the discharge unit 20. The discharge unit 20 discharges the sheet S to the discharge tray 60. An airflow path 53 through which air is mutually movable exists between the fixing device 11 and the pair of conveying rollers 51.

### 2. Fixing Device and Second Conveying Path

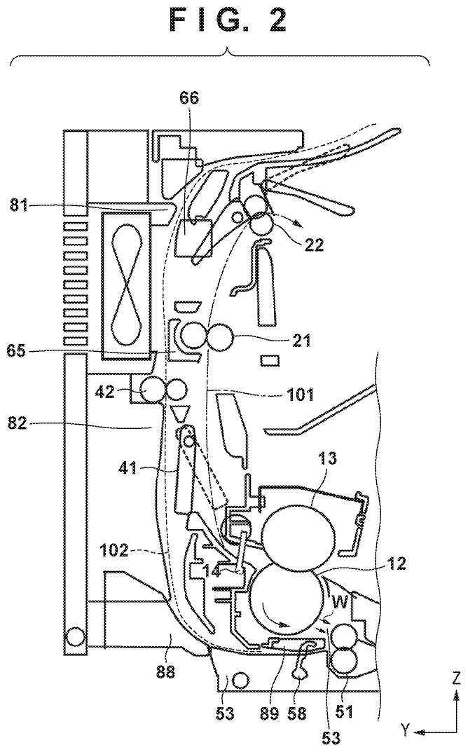

FIG. 2 is an enlarged view showing the vicinity of the fixing device 11 of the image forming apparatus 100. The image forming apparatus 100 has a conveying guide 65 and a conveying guide 66 that partition the first conveying path 101 and the second conveying path 102 and guide the sheet S. The conveying guide 65 is disposed on a downstream side of the flapper 41. The conveying guide 66 is disposed on a downstream side of the conveying guide 65.

A flag 14 is provided on a downstream side of the fixing device 11 in the first conveying path 101. The flag 14 is a detection member for detecting arrival of a leading end of the sheet S discharged from the fixing device 11 and passage of a trailing end of the sheet S. As the flag 14 is pushed by the sheet S and rotates, a photo-interrupter type sheet sensor, which will be described later, transitions from a light-transmitting state to a light-shielding state. Thereby, the sheet S is detected.

Reversing guides 81, 82 are disposed in the second conveying path 102. The reversing guide 81 is provided on a +Z side of the pair of reversing rollers 42, and guides the sheet S conveyed through the second conveying path 102. The reversing guide 82 is provided on a-Z side of the pair of reversing rollers 42, and guides the sheet S conveyed through the second conveying path 102.

The second conveying path 102 is bent from a −Z direction toward a −Y direction. A lower guide 88 that guides the sheet S is provided at this bent portion. Note that, a portion of the second conveying path 102 located on the +Z side of the flapper 41 may be called a reversal conveying section. A portion of the second conveying path 102 located on the −Z side of the flapper 41 may be called a sub-conveying section.

A lower guide 89 that guides the sheet S to the sub-conveying unit 50 is disposed in the sub-conveying section.

In the sub-conveying section, a flag 58 is provided in front of the pair of conveying rollers 51. In double-sided printing, when the flag 58 is rotated by the sheet S, the pair of conveying rollers 51 starts rotation. Thereby, the pair of conveying rollers 51 conveys the sheet S having the image formed on the first surface.

Incidentally, the fixing device 11 has a heating roller 13 and a pressure roller 12. The heating roller 13 is a cylindrical film that rotates while being driven by the pressure roller 12. A heater is disposed inside the heating roller 13. Heat generated by the heater melts the image via the heating roller 13, and fixes the image to the sheet S. The pressure roller 12 is biased toward the heating roller 13, and pressurizes the sheet S and the image passing through a nip portion between the heating roller 13 and the pressure roller 12.

Here, in a Z direction, the height of a lower end portion of the pressure roller 12 and the height of an upper end portion of the pair of conveying rollers 51 are substantially the same. In a Y direction, the position of a right end of the heating roller 13 and the position of a left end of the pair of conveying rollers 51 are substantially the same. That is, when viewing the pressure roller 12 and the pair of conveying rollers 51 from a horizontal direction, the pressure roller 12 and the pair of conveying rollers 51 appear to overlap. When viewing the heating roller 13 and the pair of conveying rollers 51 from a vertical direction, the heating roller 13 and the pair of conveying rollers 51 appear to overlap.

The pair of conveying rollers 51 may be driven by a motor common to any pair of conveying rollers that conveys the sheet S in the first conveying path 101. In this case, a clutch is adopted between the motor and the pair of conveying rollers 51. The clutch transmits or cuts off a driving force of the motor to the pair of conveying rollers 51. A motor that rotationally drives the pair of conveying rollers 51 and a motor that rotationally drives any pair of conveying rollers that conveys the sheet S in the first conveying path 101 may be different motors.

### 3. Reduction of Condensation

The fixing device 11 heats the sheet S and the image. Therefore, moisture contained in the sheet S evaporates, and water vapor W is generated. As FIG. 2 shows, the water vapor W is agitated by an airflow generated by rotation of the pressure roller 12, and moves in the −Y direction. The pair of conveying rollers 51 exists in the −Y direction of the fixing device 11. Therefore, the water vapor W adheres to the pair of conveying rollers 51 and the like. When the image forming apparatus 100 is in a relatively low temperature state, condensation occurs on the pair of conveying rollers 51. Condensation is a phenomenon in which water vapor W is condensed and becomes water droplets.

In double-sided printing, if the sheet S passes through the pair of conveying rollers 51 to which water droplets have adhered, the sheet S gets wet. In particular, when the image forming apparatus 100 has not warmed up, if single-sided printing is executed, condensation easily occurs on a surface of the pair of conveying rollers 51.

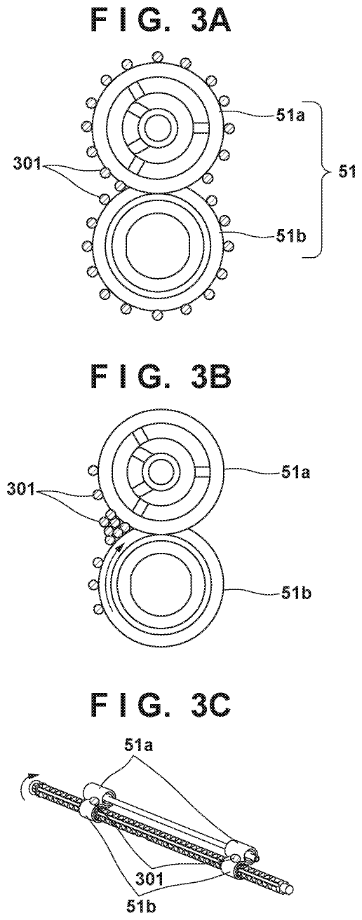

FIGS. 3A to 3C show states where condensation has occurred on the pair of conveying rollers 51. Here, the pair of conveying rollers 51 is formed from an upper roller 51a and a lower roller 51b.

As FIG. 3A shows, during single-sided printing, the upper roller 51a and the lower roller 51b are not rotating. Condensation occurs on a surface of the upper roller 51a and a surface of the lower roller 51b. As the number of sheets S for which single-sided printing is executed increases, the amount of water vapor W generated from the sheet S in the fixing device 11 increases. Therefore, the amount of water droplets 301 adhering to the surface of the upper roller 51a and the surface of the lower roller 51b also increases.

Double-sided printing may be executed after single-sided printing is repeatedly executed. In this case, the pair of conveying rollers 51 rotates in order to convey the sheet S having the image formed on the first surface. As FIG. 3B shows, the upper roller 51a rotates counterclockwise, and the lower roller 51b rotates clockwise. Thereby, the water droplets 301 that had adhered to the upper roller 51a and the water droplets 301 that had adhered to the lower roller 51b are conveyed to a nip portion between the upper roller 51a and the lower roller 51b.

As FIG. 3C shows, the water droplets 301 gathered at the nip portion become a large spherical water droplet 301 due to surface tension and stay at the nip portion. In this state, when the pair of conveying rollers 51 receives the sheet S, the spherical water droplet 301 gathered at the nip portion of the pair of conveying rollers 51 adheres to the sheet S, which may lead to a defect in an image formed on the second surface of the sheet S.

The amount of water vapor W is proportional to the number of sheets S for which single-sided printing is executed. As the number of sheets S for which single-sided printing is executed increases, the amount of water droplets 301 adhering to the pair of conveying rollers 51 also increases. On the other hand, as the number of sheets S for which single-sided printing is executed increases, the temperature inside the housing of the image forming apparatus 100 rises. When the image forming apparatus 100 warms up, the water droplets 301 adhering to the pair of conveying rollers 51 return to water vapor W again. That is, even if water droplets 301 form on the pair of conveying rollers 51, when the image forming apparatus 100 warms up, the water droplets 301 adhering to the pair of conveying rollers 51 decrease.

Therefore, so that the water vapor W becomes less likely to cause condensation on the pair of conveying rollers 51, in single-sided printing, the pair of conveying rollers 51 is rotationally driven during a period from when the leading end of the sheet S arrives at the flag 14 until when the trailing end of the sheet S passes the flag 14. Here, the pair of conveying rollers 51 is rotationally driven during a part or all of a passage time of the sheet S. Thereby, air around the pair of conveying rollers 51 is agitated, and water droplets become less likely to attach to the pair of conveying rollers 51. When the temperature inside the housing of the image forming apparatus 100 rises to a temperature at which the water droplets 301 on the pair of conveying rollers 51 are reduced, a driving time of the pair of conveying rollers 51 may be shortened.

Thereby, wetting of the sheet S will be reduced while reducing power consumption. For example, power consumption of a motor that rotationally drives the pair of conveying rollers 51 will be reduced. Furthermore, a reduction in image quality that had been caused by the sheet S getting wet will be suppressed.

### 4. Controller

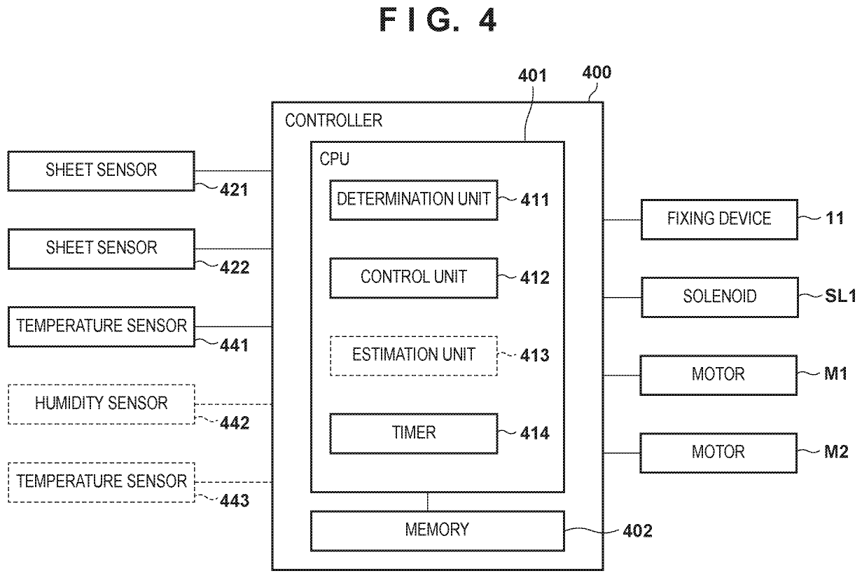

FIG. 4 shows a controller 400 of the image forming apparatus 100. Here, only components necessary for condensation reduction processing are illustrated.

A CPU 401 controls the image forming apparatus 100 by executing a control program stored in a ROM area of a memory 402. ROM is an abbreviation for read-only memory and is an example of a non-volatile memory here. The memory 402 has a RAM area. RAM is an abbreviation for random-access memory and is an example of a volatile memory. The CPU 401, for example, executes temperature control of the fixing device 11 and conveyance control of the sheet S. A solenoid SL1 drives the flapper 41. A motor M1 rotationally drives the pair of reversing rollers 42. The motor M1 can rotate in a forward direction and a reverse direction. A motor M2 rotationally drives the pair of conveying rollers 51. When the motor M2 also supplies rotational force to a pair of conveying rollers that conveys the sheet S in the first conveying path 101, an electromagnetic clutch may be provided between the motor M2 and the pair of conveying rollers 51. The CPU 401 transmits/cuts off the rotational force from the motor M2 to the pair of conveying rollers 51 by turning on/off the electromagnetic clutch.

A sheet sensor 421 has a light-emitting element (example: light-emitting diode) and a light-receiving element (example: phototransistor), and a flag 14 functioning as a light-shielding member and a light-transmitting member is provided between the light-emitting element and the light-receiving element. For example, when the leading end of the sheet S discharged from the fixing device 11 pushes down the flag 14, the sheet sensor 421 enters a light-shielding state (or light-transmitting state). When the trailing end of the sheet S discharged from the fixing device 11 leaves the flag 14, the sheet sensor 421 enters a light-transmitting state (or light-shielding state).

A sheet sensor 422 has a light-emitting element and a light-receiving element, and a flag 58 functioning as a light-shielding member and a light-transmitting member is provided between the light-emitting element and the light-receiving element. For example, when the leading end of the sheet S conveyed through the second conveying path 102 pushes down the flag 58, the sheet sensor 422 enters a light-shielding state (or light-transmitting state). When the trailing end of the sheet S conveyed through the second conveying path 102 leaves the flag 58, the sheet sensor 422 enters a light-transmitting state (or light-shielding state).

A temperature sensor 441 detects a temperature of an environment where the image forming apparatus 100 is installed (environmental temperature). A humidity sensor 442 detects a humidity of the environment where the image forming apparatus 100 is installed (environmental humidity). A temperature sensor 443 detects a temperature inside the housing of the image forming apparatus 100 (internal temperature).

The CPU 401 realizes various functions by executing a control program. Note that one or a plurality of the following functions may be implemented in another integrated circuit outside the CPU 401. A determination unit 411 determines whether condensation reduction processing is necessary based on an evaluation value indicating ease of occurrence of condensation on the pair of conveying rollers 51, such as the environmental temperature, the environmental humidity, the internal temperature, and the like.

A control unit 412 controls the fixing device 11, the solenoid SL1, and the motors M1, M2. For example, when single-sided printing is specified by a print job, the control unit 412 controls the motor M2 and causes the motor M2 to temporarily rotationally drive the pair of conveying rollers 51. An estimation unit 413 is optional and estimates the amount of moisture contained in the sheet S (moisture content amount) based on the environmental temperature and the environmental humidity. A timer 414 measures time in order to manage timing when the pair of conveying rollers 51 starts rotation and timing when it ends rotation in the condensation reduction processing.

### 5. Flowchart

### 5-1. Main Flowchart

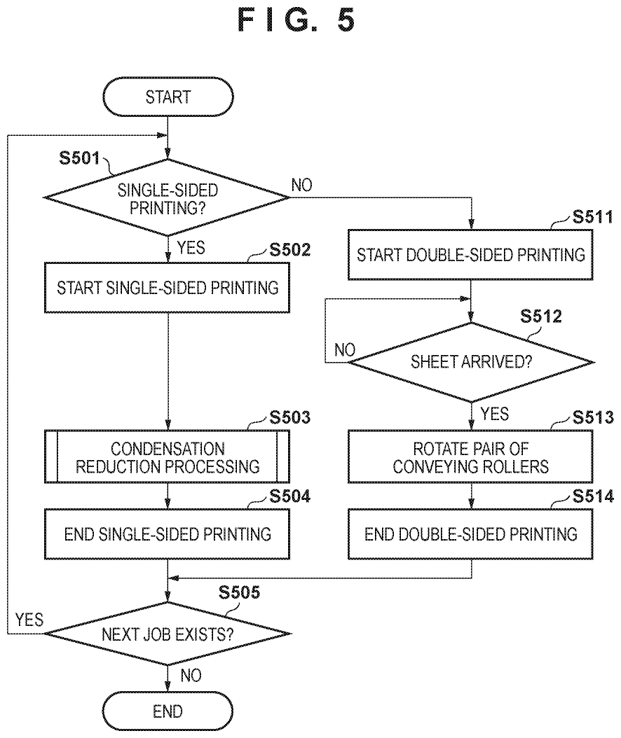

FIG. 5 shows a control method executed by the CPU 401 according to a control program. When a user inputs a print job, the CPU 401 executes the following processing.

In step S501, the CPU 401 (determination unit 411) determines whether single-sided printing has been specified by the print job. When single-sided printing is specified, the CPU 401 proceeds from step S501 to step S502. When double-sided printing is specified, the CPU 401 proceeds from step S501 to step S511.

In step S502, the CPU 401 (control unit 412) starts single-sided printing. The CPU 401 causes the feeding unit 30 to feed a sheet S, causes the image forming unit 10 to form an image on the sheet S, and causes the fixing device 11 to fix the image on the sheet S.

In step S503, the CPU 401 (control unit 412) executes condensation reduction processing. Details of the condensation reduction processing will be described later.

In step S504, the CPU 401 (control unit 412) ends the single-sided printing. The control unit 412 controls the flapper 41 and delivers the sheet S to the pair of conveying rollers 21. The pair of conveying rollers 21 and the pair of discharge rollers 22 discharge the sheet S to the discharge tray 60.

In step S505, the CPU 401 (determination unit 411) determines whether a next job exists. If there is no next job, the CPU 401 ends the control method. If there is a next job, the CPU 401 returns from step S505 to step S501.

In step S511, the CPU 401 (control unit 412) starts double-sided printing. The control unit 412 controls the image forming unit 10 to form an image on the first surface of the sheet S. The control unit 412 controls the flapper 41 and guides the sheet S to the reversing section of the second conveying path 102. The control unit 412 causes the pair of reversing rollers 42 to rotate in the forward direction by the motor M1 to guide the sheet S to the reversal conveying section, and causes the pair of reversing rollers 42 to rotate in the reverse direction by the motor M1 to send the sheet S into the sub-conveying section of the second conveying path 102.

In step S512, the CPU 401 (determination unit 411) determines whether the sheet S has arrived at the flag 58 of the sheet sensor 422. When the sheet sensor 422 detects arrival of the sheet S, the CPU 401 proceeds from step S512 to step S513.

In step S513, the CPU 401 (control unit 412) starts the motor M2 and rotates the pair of conveying rollers 51. Thereby, the sheet S is conveyed through the sub-conveying section and is conveyed from the second conveying path 102 to the first conveying path 101. The image forming unit 10 forms an image on the second surface of the sheet S. The fixing device 11 fixes the image on the second surface of the sheet S. The flapper 41 guides the sheet S to the pair of conveying rollers 21. The pair of conveying rollers 21 and the pair of discharge rollers 22 discharge the sheet S to the discharge tray 60.

In step S514, the CPU 401 ends the double-sided printing. Thereafter, the CPU 401 proceeds from step S514 to step S505.

### 5-2. Condensation Reduction Processing

Condensation reduction processing is processing in which the pair of conveying rollers 51 temporarily rotates without conveying the sheet S in single-sided printing. For example, the pair of conveying rollers 51 rotates during a part of a period in which the sheet S is passing through the fixing device 11. The pair of conveying rollers 51 may rotate for a predetermined time immediately after the sheet S has passed through the fixing device 11. The condensation reduction processing is executed every time one sheet S passes through the fixing device 11. However, the condensation reduction processing may be executed every time a predetermined number N of sheets S pass through the fixing device 11. In a situation where condensation easily occurs, the predetermined number N is set to a small value. In a situation where condensation hardly occurs, the predetermined number N is set to a large value.

### 5-2-1. Basic Processing

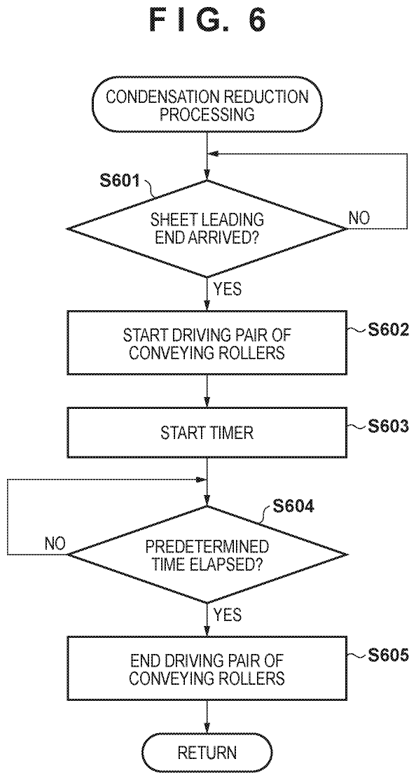

FIG. 6 shows basic condensation reduction processing. In step S601, the CPU 401 (determination unit 411) determines whether the leading end of the sheet S has arrived at the flag 14 based on a detection result of the sheet sensor 421.

In step S602, the CPU 401 (control unit 412) starts the motor M2 to start driving of the pair of conveying rollers 51. Thereby, the pair of conveying rollers 51 starts rotation.

In step S603, the CPU 401 (control unit 412) starts the timer 414. Here, a predetermined time is set in the timer 414. The predetermined time is a fixed value stored in the memory 402. However, the predetermined time may be determined according to the internal temperature acquired by the temperature sensor 443. In this case, a mathematical formula, a table, or a program module for obtaining the predetermined time from the internal temperature is stored in the ROM area of the memory 402 and is used by the CPU 401.

In step S604, the CPU 401 (determination unit 411) acquires time from the timer 414 and determines whether the predetermined time has elapsed based on the acquired time. When the predetermined time has elapsed, the CPU 401 proceeds from step S604 to step S605.

In step S605, the CPU 401 (control unit 412) stops the motor M2 and ends the driving of the pair of conveying rollers 51.

In this way, in single-sided printing, the pair of conveying rollers 51 rotates during a predetermined time within a period in which the sheet S is passing through the fixing device 11. Thereby, adherence of the water droplets 301 to the pair of conveying rollers 51 is reduced. Also, the water droplets 301 adhering to the pair of conveying rollers 51 can be removed.

### 5-2-2. Modification A

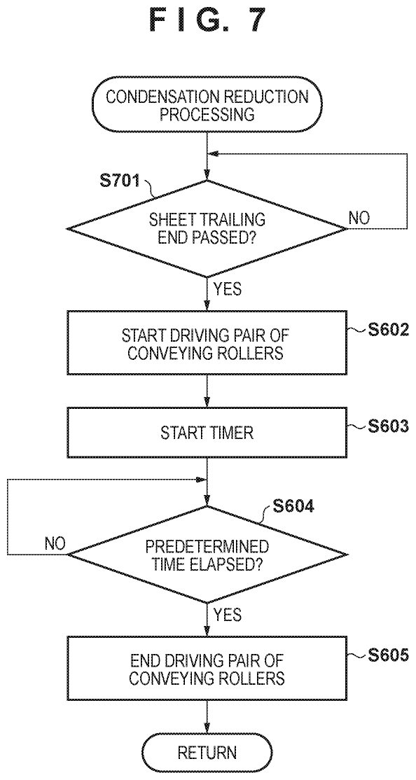

FIG. 7 shows a modification of the condensation reduction processing. Here, step S601 of FIG. 6 is replaced with step S701. In step S701, the CPU 401 (determination unit 411) determines whether the trailing end of the sheet S has passed the flag 14 based on the detection result of the sheet sensor 421. When the trailing end of the sheet S has passed the flag 14, the CPU 401 proceeds from step S701 to step S602. That is, the pair of conveying rollers 51 temporarily rotates for a predetermined time.

In this way, the rotation of the pair of conveying rollers 51 for reducing condensation in single-sided printing may be executed immediately after the period in which the sheet S is passing through the fixing device 11. Note that the predetermined time may span across the period in which the sheet S is passing through the fixing device 11 and a period in which the sheet S is not passing through the fixing device 11.

### 5-2-3. Modification B

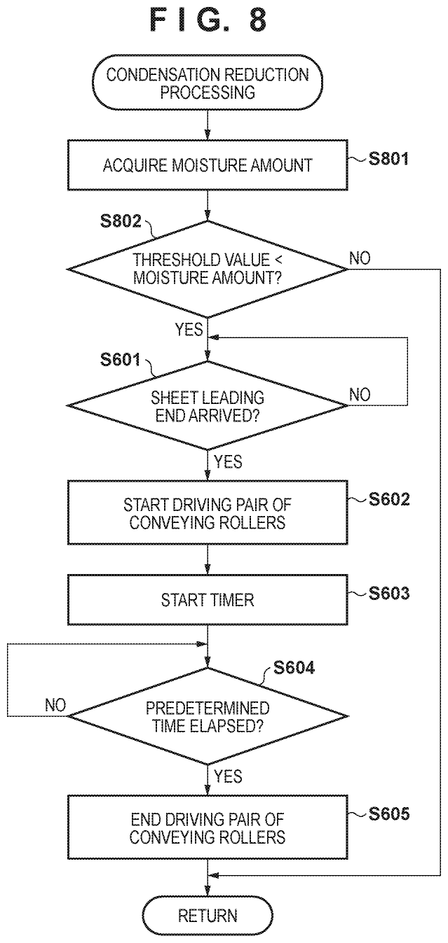

FIG. 8 shows a modification of the condensation reduction processing. Here, step S801 and step S802 are added before step S601 of FIG. 6. The generation amount of water vapor W depends on the amount of moisture contained in the sheet S.

Therefore, the predetermined time is adjusted based on the moisture amount of the sheet S estimated from the environmental temperature and the environmental humidity.

In step S801, the CPU 401 (estimation unit 413) acquires the moisture amount of the sheet S. The estimation unit 413 may estimate the moisture amount contained in the sheet S based on the environmental temperature acquired from the temperature sensor 441 and the environmental humidity acquired from the humidity sensor 442. Here, a mathematical formula, a table, or a program module for obtaining the moisture amount from the environmental temperature and the environmental humidity is stored in the ROM area of the memory 402. The CPU 401 obtains the moisture amount from the environmental temperature and the environmental humidity using the mathematical formula, the table, or the program module.

In step S802, the CPU 401 (determination unit 411) determines whether the acquired moisture amount exceeds a threshold value. When the moisture amount exceeds the threshold value, the CPU 401 proceeds from step S802 to step S601. When the moisture amount does not exceed the threshold value, the CPU 401 skips step S601 to step S605.

In this way, when the acquired moisture amount exceeds the threshold value, the pair of conveying rollers 51 rotates for a predetermined time. In FIG. 8, when the acquired moisture amount does not exceed the threshold value, the predetermined time is set to zero. However, this is only an example. The pair of conveying rollers 51 may rotate also when the acquired moisture amount does not exceed the threshold value. The predetermined time when the acquired moisture amount exceeds the threshold value is set longer than the predetermined time when the acquired moisture amount does not exceed the threshold value.

### 5-2-4. Modification C

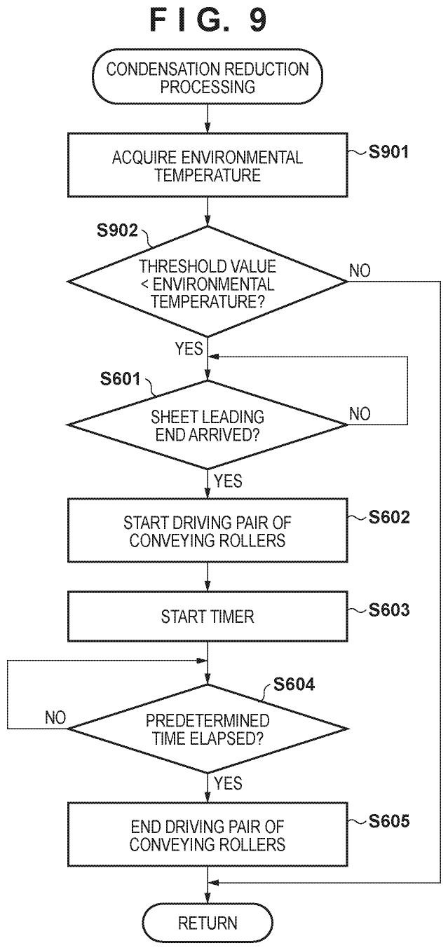

FIG. 9 shows a modification of the condensation reduction processing. Here, step S901 and step S902 are added before step S601 of FIG. 6. As the environmental temperature becomes higher, the amount of moisture contained in the sheet S increases. Therefore, as the environmental temperature is higher, the rotation time of the pair of conveying rollers 51 may be increased.

In step S901, the CPU 401 (determination unit 411) acquires the environmental temperature based on a detection result of the temperature sensor 441.

In step S902, the CPU 401 (determination unit 411) determines whether the acquired environmental temperature exceeds a threshold value. When the environmental temperature exceeds the threshold value (example: 28° C.), the CPU 401 proceeds from step S902 to step S601. When the environmental temperature does not exceed the threshold value, the CPU 401 skips step S601 to step S605.

In this way, when the acquired environmental temperature exceeds the threshold value, the pair of conveying rollers 51 rotates for a predetermined time. In FIG. 9, when the acquired environmental temperature does not exceed the threshold value, the predetermined time is set to zero. However, this is only an example. The pair of conveying rollers 51 may rotate also when the acquired environmental temperature does not exceed the threshold value. The predetermined time when the acquired environmental temperature exceeds the threshold value is set longer than the predetermined time when the acquired environmental temperature does not exceed the threshold value.

### 5-2-5. Modification D

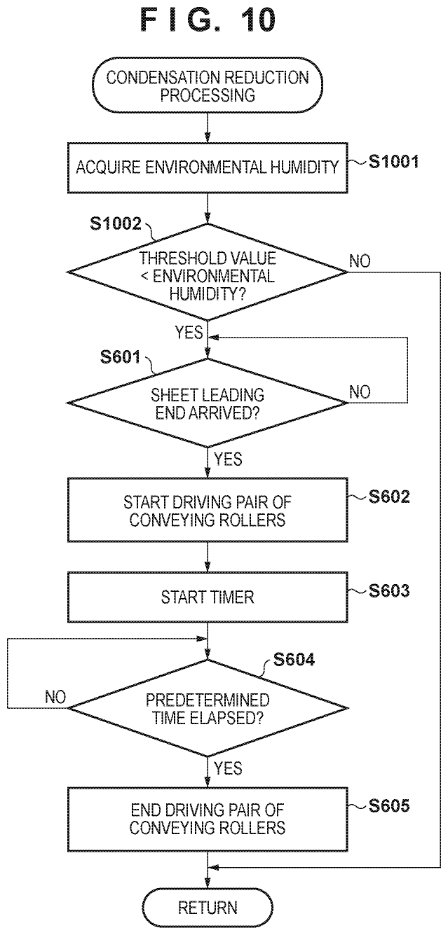

FIG. 10 shows a modification of the condensation reduction processing. Here, step S1001 and step S1002 are added before step S601 of FIG. 6. As the environmental humidity becomes higher, the amount of moisture contained in the sheet S increases. Therefore, as the environmental humidity is higher, the rotation time of the pair of conveying rollers 51 is increased.

In step S1001, the CPU 401 (determination unit 411) acquires the environmental humidity based on a detection result of the humidity sensor 442.

In step S1002, the CPU 401 (determination unit 411) determines whether the acquired environmental humidity exceeds a threshold value. When the environmental humidity exceeds the threshold value, the CPU 401 proceeds from step S1002 to step S601. When the environmental humidity does not exceed the threshold value, the CPU 401 skips step S601 to step S605.

In this way, when the acquired environmental humidity exceeds the threshold value, the pair of conveying rollers 51 rotates for a predetermined time. In FIG. 10, when the acquired environmental humidity does not exceed the threshold value, the predetermined time is set to zero. However, this is only an example. The pair of conveying rollers 51 may rotate also when the acquired environmental humidity does not exceed the threshold value. The predetermined time when the acquired environmental humidity exceeds the threshold value is set longer than the predetermined time when the acquired environmental humidity does not exceed the threshold value.

### 5-2-6. Modification E

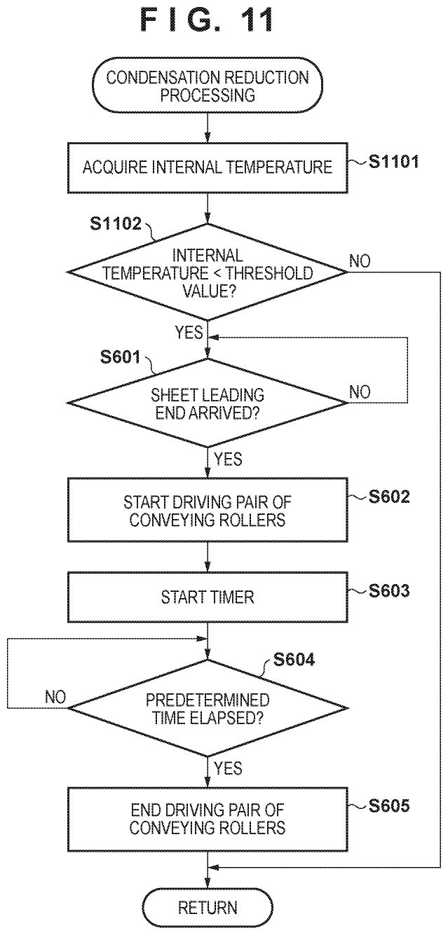

FIG. 11 shows a modification of the condensation reduction processing. Here, step S1101 and step S1102 are added before step S601 of FIG. 6. As the temperature inside the housing of the image forming apparatus 100 (internal temperature) is lower, the surface temperature of the pair of conveying rollers 51 decreases and condensation more easily occurs. Therefore, as the internal temperature is lower, the rotation time of the pair of conveying rollers 51 may be increased.

In step S1101, the CPU 401 (determination unit 411) acquires the internal temperature based on a detection result of the temperature sensor 443.

In step S1102, the CPU 401 (determination unit 411) determines whether the acquired internal temperature is less than a threshold value. When the internal temperature is equal to the threshold value or exceeds the threshold value, condensation hardly occurs on the pair of conveying rollers 51. Therefore, the CPU 401 skips step S601 to step S605.

When the internal temperature is less than the threshold value, the possibility that condensation occurs on the pair of conveying rollers 51 is relatively high. Therefore, the CPU 401 proceeds from step S1102 to step S601. In this way, the internal temperature is considered to be generally close to the surface temperature of the pair of conveying rollers 51. As the surface temperature decreases, condensation more easily occurs on the pair of conveying rollers 51. Therefore, when the internal temperature is less than the threshold value, the pair of conveying rollers 51 rotates for a predetermined time. In FIG. 11, when the acquired internal temperature is equal to or higher than the threshold value, the predetermined time is set to zero. However, this is only an example. The pair of conveying rollers 51 may rotate also when the acquired internal temperature is equal to or higher than the threshold value. The predetermined time when the acquired internal temperature is less than the threshold value is set longer than the predetermined time when the acquired internal temperature is equal to or higher than the threshold value.

### 5-2-7. Modification F

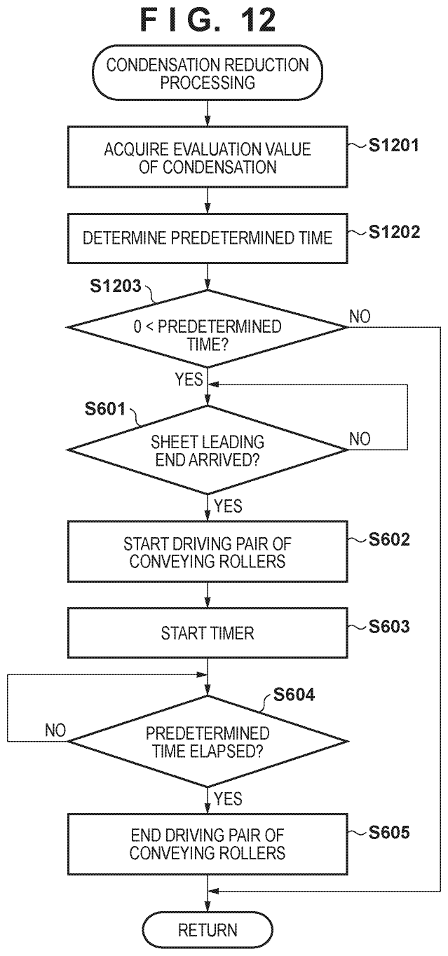

FIG. 12 shows a modification of the condensation reduction processing. Here, step S1201, step S1202, and step S1203 are added before step S601 of FIG. 6. As the evaluation value of condensation becomes higher, the predetermined time is increased. As the evaluation value of condensation becomes lower, the predetermined time is reduced. This brings about a further reduction in power consumption.

In step S1201, the CPU 401 (estimation unit 413) acquires the evaluation value of condensation for the pair of conveying rollers 51. The evaluation value of condensation is, for example, the environmental temperature, the environmental humidity, the internal temperature, or the amount of moisture contained in the sheet S. The evaluation value of condensation may be obtained by calculation from one or a plurality of these. A mathematical formula, a table, or a program module for this calculation is stored in the ROM area of the memory 402. The CPU 401 calculates the evaluation value using the mathematical formula, the table, or the program module. Note that the environmental temperature, the environmental humidity, and the amount of moisture contained in the sheet S are factors that increase the evaluation value. The internal temperature is a factor that decreases the evaluation value.

In step S1202, the CPU 401 (estimation unit 413) calculates the predetermined time based on the evaluation value of condensation. A mathematical formula, a table, or a program module for calculating the predetermined time from the evaluation value of condensation is stored in the ROM area of the memory 402. The CPU 401 calculates the predetermined time using the mathematical formula, the table, or the program module.

In step S1203, the CPU 401 (determination unit 411) determines whether the predetermined time exceeds 0. When the predetermined time exceeds 0, the CPU 401 proceeds from step S1203 to step S601. When the evaluation value of condensation is 0, the CPU 401 skips step S601 to step S605.

In this way, the predetermined time is determined according to the acquired evaluation value of condensation. As the acquired evaluation value of condensation is higher, the predetermined time is set longer. As the acquired evaluation value of condensation is lower, the predetermined time is set shorter.

### 6. Summary

The feeding unit 30 is an example of a feeding unit that feeds the sheet S. The image forming unit 10 is an example of an image forming unit that forms an image on the sheet S. The discharge unit 20 is an example of a discharge unit that discharges the sheet S. The first conveying path 101 is an example of a conveying path extending from the feeding unit to the discharge unit via the image forming unit. The second conveying path 102 is an example of a conveying path that branches from the first conveying path 101 on a downstream side of the image forming unit in the conveying direction of the sheet S and joins the first conveying path 101 on an upstream side of the image forming unit. The pair of conveying rollers 51 is an example of a conveying unit that conveys the sheet S passing through the second conveying path 102. The pair of conveying rollers 51, in single-sided printing in which an image is formed on the first surface of the sheet S and an image is not formed on the second surface of the sheet S, temporarily rotates for a predetermined time without conveying the sheet S. In the conventional technology, the pair of conveying rollers was always rotating during single-sided printing. In contrast, according to the present embodiment, since the pair of conveying rollers 51 temporarily rotates during single-sided printing, power consumption for reducing condensation is reduced compared to the conventional technology. Thereby, fixability of the image to the sheet S is also maintained. There is a possibility that a driving circuit of the motor M2 necessary for driving the pair of conveying rollers 51 can be downsized. This can alleviate an increase in size of the housing of the image forming apparatus 100.

The fixing device 11 is an example of a heating unit that heats the sheet S and the image. The pair of conveying rollers 51 is disposed at a position that is in contact with the water vapor W that occurs from the sheet S passing through the fixing device 11. When the water vapor W contacts the cooled pair of conveying rollers 51, condensation occurs on the pair of conveying rollers 51. Therefore, the condensation reduction processing becomes necessary for the pair of conveying rollers 51. Therefore, the condensation reduction processing of the present embodiment is effective.

The fixing device 11 includes a heating rotating body (example: heating roller 13) and a pressure rotating body (example: pressure roller 12) that rotate while abutting each other. The pair of conveying rollers 51 is disposed at a position exposed to an airflow generated by rotation of at least one of the heating rotating body and the pressure rotating body. In other words, the image forming apparatus 100 includes the airflow path 53, and through the airflow path 53, the airflow flows from at least one of the heating rotating body and the pressure rotating body to the pair of conveying rollers 51 (more specifically, the upper roller 51a). This airflow path 53 is an airflow path 53 different from the first conveying path 101 and the second conveying path 102, and in the present embodiment, is disposed between the first conveying path 101 and the second conveying path 102. As is clear from FIG. 1 and FIG. 2, the airflow path 53 is disposed inside a closed loop formed by the first conveying path 101 and the second conveying path 102 as viewed in a direction of a rotation axis of the upper roller 51a. Such an airflow ends up carrying the water vapor W that occurs in the fixing device 11 to the pair of conveying rollers 51. Therefore, the condensation reduction processing of the present embodiment is effective.

The pair of conveying rollers 51 is disposed below the heating unit (example: fixing device 11) in the vertical direction. The pair of conveying rollers 51 includes a first conveying rotating body (example: upper roller 51a) and a second conveying rotating body (example: lower roller 51b) that rotate while abutting each other. As suggested by FIG. 1 and FIG. 2, at least one of the first conveying rotating body and the second conveying rotating body may be disposed below the heating unit. The pair of conveying rollers 51 may be disposed to the side of the fixing device 11 in the horizontal direction. At least one of the first conveying rotating body and the second conveying rotating body may be disposed to the side of the heating unit. In these arrangements, the pair of conveying rollers 51 is easily affected by the water vapor W that occurs in the fixing device 11. Therefore, the condensation reduction processing of the present embodiment is effective.

In single-sided printing, the pair of conveying rollers 51 rotates during the period in which the sheet S is passing through the fixing device 11. The water vapor W is formed by evaporation of moisture contained in the sheet S in the fixing device 11. Therefore, by the pair of conveying rollers 51 rotating during the period in which the sheet S is passing through the fixing device 11, condensation is efficiently reduced.

The flag 14 and the sheet sensor 421 are an example of a detection unit that detects the sheet S passing through on a downstream side or an upstream side of the fixing device 11 in the first conveying path 101. Note that the flag 14 may be disposed on the upstream side of the fixing device 11. In single-sided printing, the pair of conveying rollers 51 rotates during a predetermined time included within a time during which the detection unit is detecting the sheet S. Thereby, the rotation time of the pair of conveying rollers 51 is reduced, and power consumption is reduced.

As FIG. 7 shows, in single-sided printing, the pair of conveying rollers 51 may rotate during a predetermined time immediately after the time during which the flag 14 and the sheet sensor 421 are detecting the sheet S.

In this way, the rotation period of the pair of conveying rollers 51 may exist outside the period in which the sheet S is passing the flag 14 (passage period). As FIG. 6 shows, the rotation period exists inside the passage period. Note that the rotation period may span across the inside and the outside of the passage period.

The temperature sensor 441, the humidity sensor 442, and the estimation unit 413 function as a measurement unit that measures the amount of moisture contained in the sheet S. As FIG. 8 shows, in single-sided printing, the rotation time of the pair of conveying rollers 51 when the amount of moisture exceeds a predetermined value is longer than the rotation time of the pair of conveying rollers 51 when the amount of moisture does not exceed the predetermined value. Thereby, in a situation where condensation is likely to occur, the condensation reduction processing comes to be executed for a longer time. As FIG. 8 shows, the rotation time of the pair of conveying rollers 51 when the amount of moisture does not exceed the predetermined value may be zero.

The temperature sensor 441 is an example of a measurement unit that measures the temperature of the environment where the image forming apparatus 100 is installed. As FIG. 9 shows, in single-sided printing, the rotation time of the pair of conveying rollers 51 when the temperature of the environment exceeds a predetermined value is longer than the rotation time of the pair of conveying rollers 51 when the temperature of the environment does not exceed the predetermined value. Thereby, in a situation where condensation is likely to occur, the condensation reduction processing comes to be executed for a longer time. As FIG. 9 shows, the rotation time of the pair of conveying rollers 51 when the temperature of the environment does not exceed the predetermined value may be zero.

The humidity sensor 442 is an example of a measurement unit that measures the humidity of the environment where the image forming apparatus 100 is installed. As FIG. 10 shows, in single-sided printing, the rotation time of the pair of conveying rollers 51 when the humidity of the environment exceeds a predetermined value is longer than the rotation time of the pair of conveying rollers 51 when the humidity of the environment does not exceed the predetermined value. Thereby, in a situation where condensation is likely to occur, the condensation reduction processing comes to be executed for a longer time. As FIG. 10 shows, the rotation time of the pair of conveying rollers 51 when the humidity of the environment does not exceed the predetermined value may be zero.

The temperature sensor 443 functions as a measurement unit that measures the temperature inside the housing of the image forming apparatus 100. In single-sided printing, the rotation time of the pair of conveying rollers 51 when the temperature inside the housing exceeds a predetermined value is shorter than the rotation time of the pair of conveying rollers 51 when the temperature inside the housing does not exceed the predetermined value. When the inside of the housing warms up, the surface temperature of the pair of conveying rollers 51 becomes high. That is, since condensation becomes less likely to occur, it becomes possible to reduce the execution time of the condensation reduction. Thereby, power consumption may be further reduced. As FIG. 11 shows, the rotation time of the pair of conveying rollers 51 when the temperature inside the housing exceeds a predetermined value may be zero.

The CPU 401 functions as an acquisition unit that acquires an evaluation value indicating ease of occurrence of condensation on the pair of conveying rollers 51 (example: environmental temperature, environmental humidity, moisture content amount, temperature inside the housing). The CPU 401 may function as a determination unit that determines the predetermined time based on the acquired evaluation value. In this way, the execution time of the condensation reduction processing may be adjusted according to the ease of occurrence of condensation.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-080613, filed May 13, 2025 and 2026-033560, filed Mar. 3, 2026, all of which are hereby incorporated by reference herein in their entirety.

What is claimed is:

1. An image forming apparatus capable of performing single-sided printing in which an image is formed on a first surface of a sheet and an image is not formed on a second surface of the sheet, and capable of performing double-sided printing in which an image is formed on the first surface of the sheet and an image is formed on the second surface of the sheet, the image forming apparatus comprising:
a feeding unit configured to feed the sheet;
an image forming unit configured to form an image on the sheet;
a heating unit configured to heat the sheet;
a discharge tray;
a discharge unit configured to discharge the sheet to the discharge tray;
a first conveying path extending from the feeding unit to the discharge unit via the image forming unit;
a second conveying path branching from the first conveying path on a downstream side of the image forming unit in a conveying direction of the sheet and joining the first conveying path on an upstream side of the image forming unit;
a conveying unit disposed below the heating unit in a vertical direction, the conveying unit conveying a sheet passing through the second conveying path; and
a control unit configured to control operation of the conveying unit,
wherein the control unit rotates the conveying unit in the single-sided printing.

2. The image forming apparatus according to claim 1, wherein
the heating unit includes a heating rotating body and a pressure rotating body, both the heating rotating body and the pressure rotating body are configured to rotate while abutting each other,
the image forming apparatus further comprising an airflow path that is different from the first conveying path and the second conveying path, and that through which an airflow flowing from at least one of the heating rotating body or the pressure rotating body to the conveying unit passes.

3. The image forming apparatus according to claim 1, wherein
the conveying unit includes a first conveying rotating body and a second conveying rotating body, both the first conveying rotating body and the second conveying rotating body are configured to rotate while abutting each other, and
at least one of the first conveying rotating body or the second conveying rotating body is disposed below the heating unit.

4. The image forming apparatus according to claim 1, wherein
the conveying unit is disposed to a side of the heating unit in a horizontal direction.

5. The image forming apparatus according to claim 4, wherein
the conveying unit includes a first conveying rotating body and a second conveying rotating body, both the first conveying rotating body and the second conveying rotating body are configured to rotate while abutting each other, and
at least one of the first conveying rotating body or the second conveying rotating body is disposed to the side of the heating unit.

6. The image forming apparatus according to claim 1, further comprising
a detection unit configured to detect the sheet in the first conveying path,
wherein the control unit starts rotation of the conveying unit in the single-sided printing based on the sheet being detected by the detection unit.

7. The image forming apparatus according to claim 6, wherein
the control unit stops the conveying unit when a predetermined time has elapsed since the rotation of the conveying unit in the single-sided printing was started.

8. The image forming apparatus according to claim 1, further comprising
a flapper disposed at a branching portion between the first conveying path and the second conveying path,
wherein the flapper is movable to a first position where the sheet is conveyed toward the first conveying path and a second position where the sheet is conveyed to the second conveying path.

9. The image forming apparatus according to claim 1, further comprising
a measurement unit configured to measure an amount of moisture contained in the sheet,
wherein in the single-sided printing, a rotation time of the conveying unit when the amount of moisture exceeds a predetermined value is longer than a rotation time of the conveying unit when the amount of moisture does not exceed the predetermined value.

10. The image forming apparatus according to claim 9, wherein
the rotation time of the conveying unit when the amount of moisture does not exceed the predetermined value is zero.

11. The image forming apparatus according to claim 1, further comprising
a measurement unit configured to measure a temperature of an environment where the image forming apparatus is installed,
wherein in the single-sided printing, a rotation time of the conveying unit when the temperature of the environment exceeds a predetermined value is longer than a rotation time of the conveying unit when the temperature of the environment does not exceed the predetermined value.

12. The image forming apparatus according to claim 11, wherein the rotation time of the conveying unit when the temperature of the environment does not exceed the predetermined value is zero.

13. The image forming apparatus according to claim 1, further comprising
a measurement unit configured to measure a humidity of an environment where the image forming apparatus is installed,
wherein in the single-sided printing, a rotation time of the conveying unit when the humidity of the environment exceeds a predetermined value is longer than a rotation time of the conveying unit when the humidity of the environment does not exceed the predetermined value.

14. The image forming apparatus according to claim 13, wherein
the rotation time of the conveying unit when the humidity of the environment does not exceed the predetermined value is zero.

15. The image forming apparatus according to claim 1, further comprising
a measurement unit configured to measure a temperature inside a housing of the image forming apparatus,
wherein in the single-sided printing, a rotation time of the conveying unit when the temperature inside the housing exceeds a predetermined value is shorter than a rotation time of the conveying unit when the temperature inside the housing does not exceed the predetermined value.

16. The image forming apparatus according to claim 15, wherein
the rotation time of the conveying unit when the temperature inside the housing exceeds the predetermined value is zero.
